(19) United States
(12) Patent Application Publication
(10) Pub. No.: US 2004/0052396 A1
(43) Pub. Date: Mar. 18, 2004

(54) Stretchable tube equipped microphone

(76) Inventor: Linda Kuo, Taipei Hsien (TW)

Correspondence Address: BIRCH STEWART KOLASCH & BIRCH, PO BOX 747, FALLS CHURCH, VA, 22040-0747, US

(21) Appl. No.: 10/244,737

(22) Filed: Sep. 17, 2002

(51) Int. Cl. H04R 9/08; H04R 11/04; H04R 17/02; H04R 19/04; H04R 21/02

(52) U.S. Cl. 381/363; 381/355; 381/361; 381/362; 381/365; 381/366; 381/368

(57) ABSTRACT

A stretchable tube equipped microphone comprises a base, a supporting shall, and an acoustic head, in which the supporting shaft is pivotally jointed to the base at one end and connected to the acoustic head at the other; a switch is disposed on the base; the supporting shaft is a stretchable two-piece tube composed of an upper and a lower tube, in which the upper tube is an unbendable but stretchable hard copper tube; the diameter of the upper tube is slightly smaller than that of the lower tube; the upper tube is composed of a plurality of stretching segments and one segment thereof is buried in the lower tube; the upper tube and the lower tube are connected with the acoustic head and the base, respectively. The height and angle of the acoustic head can be adjusted according to a user's stature when using the microphone. Besides, an electric cord in helical form is arranged in the supporting shaft such that it can be stretched together with the shaft, and the structure of stretchable tube could be applied to an ear-carrying microphone.

### FIELD OF THE INVENTION

This invention relates to a stretchable tube equipped microphone.

### BACKGROUND OF THE INVENTION

A microphone, irrespective of a desktop style often used in meetings or a mobile ear-carrying style attached to ears, is more or less affected in reception capability according to a user's stature or using posture or body configuration.

As indicated in FIG. 1, an upright supporter 12 of a prior desktop microphone is usually made of a rigid metallic tube or a bendable soft tube and is fixedly and pivotally jointed to an acoustic head 11 and a base 13 of the microphone, respectively. A switch 14 is disposed on the base 13. In such a constitution, the supporter 12 cannot be stretched or shrinked freely at will so that a taller user cannot help but speak to the head 11 of the microphone in a bow posture, or, on the contrary, the platform has to be heightened up for a shorter one. The inconvenience is resulted because the supporter 12 is unadjustable that would likely provide a poor reception quality of the head 11 and could consequently even make a user suffer from an ache in waist and back after use for a long time. In the event a redundant meeting is held under a poor reception quality of the head 11, the attendants are liable to get distracted or misunderstand the speaker's original meaning to hence eventually devalue the meeting.

The same situation also happens to an ear-carrying style microphone. As shown in FIG. 2, a strip of metal is commonly adopted for making a head frame 24, which is provided at one side with a loop portion to be hung on a user's ear. Further, there are respective clamping portions arranged on two ends of the frame 24, and under the clamping portion at the same side with the loop portion, a lateral supporter 22 is extended out to support an acoustic head 21 at its other end. The major disadvantage of such an arrangement is that since the lateral supporter 22 is a stationary and unstretchable supporter designed for holding appropriately the acoustic head 21 at an optimum position close to a user's face for sound collection, it cannot make full use of the acoustic head 21 because of the unadjustable lateral supporter 22.

In view of abovesaid defects, a stretchable tube equipped microphone of this invention is provided for solving the problems in the prior arts by substituting a two-piece stretchable tube for the metallic head frame in order to facilitate the vertical adjustment of the acoustic head or the adjustment of the ear-carrying style microphone. Moreover, a stretchable electric cord is disposed in the stretchable tube for cooperation purpose.

### SUMMARY OF THE INVENTION

The primary object of this invention is to provide a stretchable tube equipped microphone, in which a supporting shaft is a two-piece stretchable tube composed of an upper tube and a lower tube, in which the upper tube has a smaller diameter than that of the lower tube; the upper tube is a hard copper tube having a stretchable structure comprising a plurality of stretchable segments to be pulled to stretch arbitrarily, while the lower tube is a bendable soft tube such that an acoustic head could be adjusted to a desired height and angle for easy use. Besides, an electric cord is formed in helical manner so as to cooperate with the stretchable tube for adjustment.

Another object of this invention is to provide a stretchable tube equipped microphone, which under a clamping portion at the same end of a hook, a lateral supporter is extended out to support an acoustic head at its other end so that the stretchable tube can always provide an optimum length of the lateral supporter according to a user's head configuration for a closer approach to the user's face and mouth for enhancing the sound collection effect of the microphone.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is a schematic view of the structure of a prior desktop microphone;

FIG. 2 is a schematic view of the structure of a prior ear-carrying microphone;

FIG. 3 is a schematic view of the microphone structure of this invention;

FIG. 4 is a three-dimensional exploded view of the microphone structure of this invention; and

FIG. 5 shows an application example of this invention.

### DETAILED DESCRIPTION OF THE INVENTION

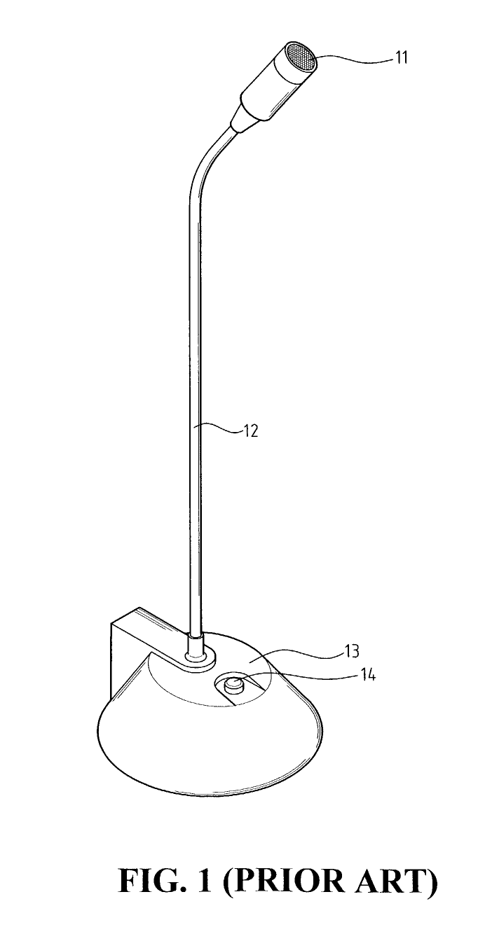

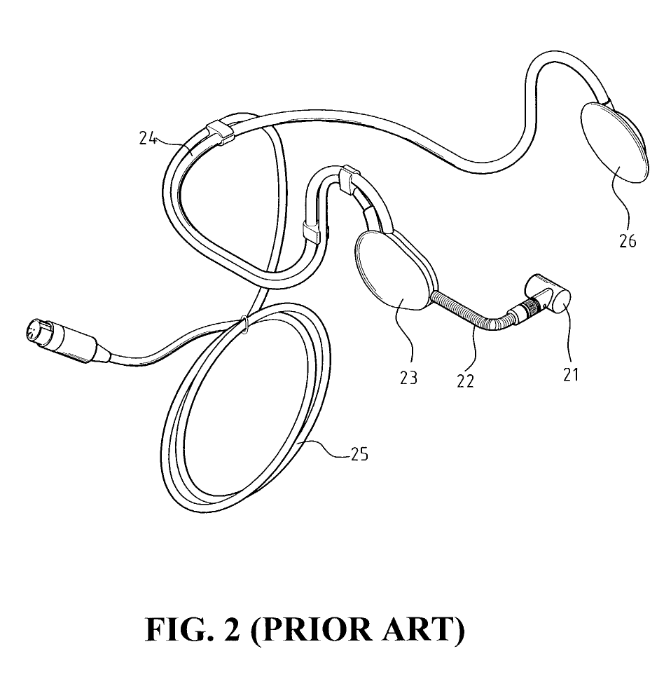

As shown in FIG. 1, a generic prior desktop microphone is composed of an acoustic head 11, a metallic supporting shaft 12, and a base 13, in which the supporting shaft 12 is connected fixedly with the head 11 and the base 13, respectively. In FIG. 2, which shows the structure of a prior ear-carrying microphone, a head frame 24 has a clamping portion 26 at each of its two ends to be fixed on a user's head laterally, in which one clamping portion serves as an earphone 23, and a lateral bracket 22 thereof with a fixed length is extended to joint with an acoustic head of microphone 21. It is therefore known from FIGS. 1 and 2 that the acoustic head 11/21 unadjustable in the structure of prior microphones would surely affect the acoustic effect, more or less.

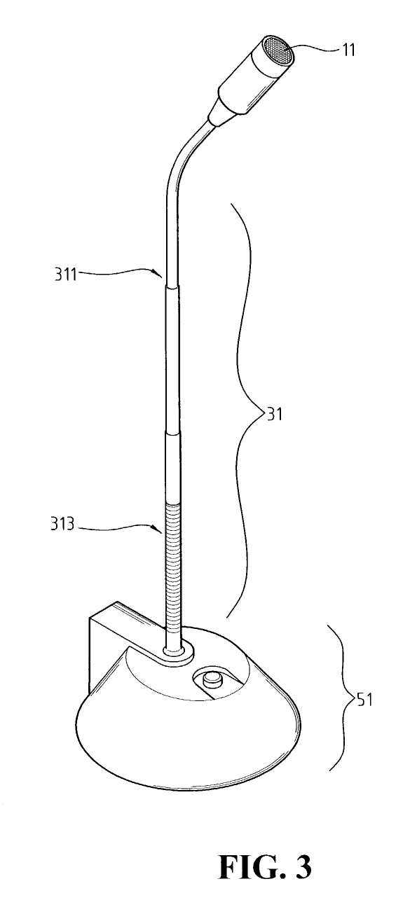

FIG. 3 is a schematic view of the microphone structure of this invention. In FIG. 3, a stretchable tube equipped microphone of this invention mainly comprises an acoustic head 11, a supporting shaft 31, and a base 51. The supporting shaft 31 is designed in form of a two-piece stretchable tube including an upper tube 311 and a lower tube 313, in which the diameter of the upper tube 311 is slightly smaller than that of the lower tube 313. The upper tube 311 further comprises a plurality of segments of hard copper tube, which is unbendable but extendable vertically, while the lower tube 313 is bendable. The upper tube 311 is in connection with the acoustic head while the lower tube 313 with the base 51. The upper tube 311 has a stretchable layer structure for providing an optimum height of the acoustic head 11 on the top of the supporting shaft 31 according to a user's stature.

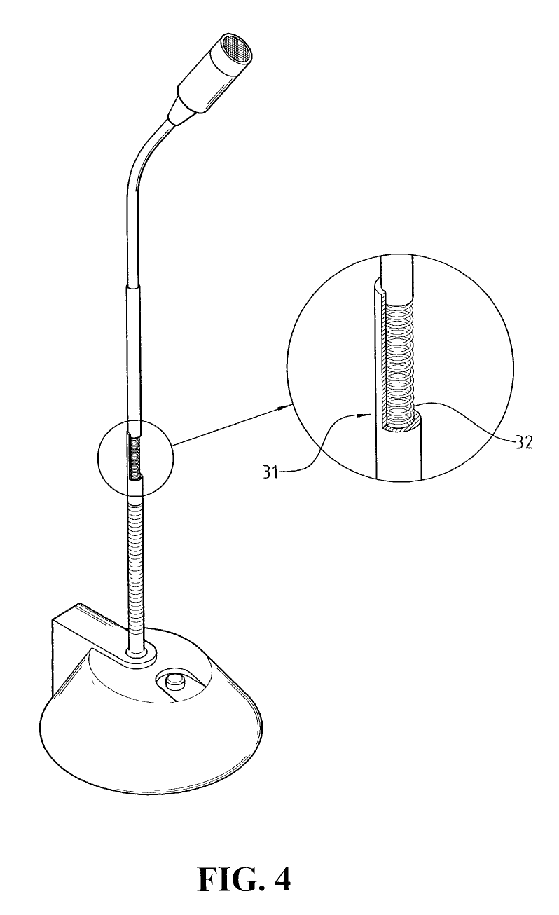

In FIG. 4—a three-dimensional exploded view of the microphone structure of this invention, an electric cord 32 concealed in the supporting shaft 31 is formed in helical manner for stretch purpose.

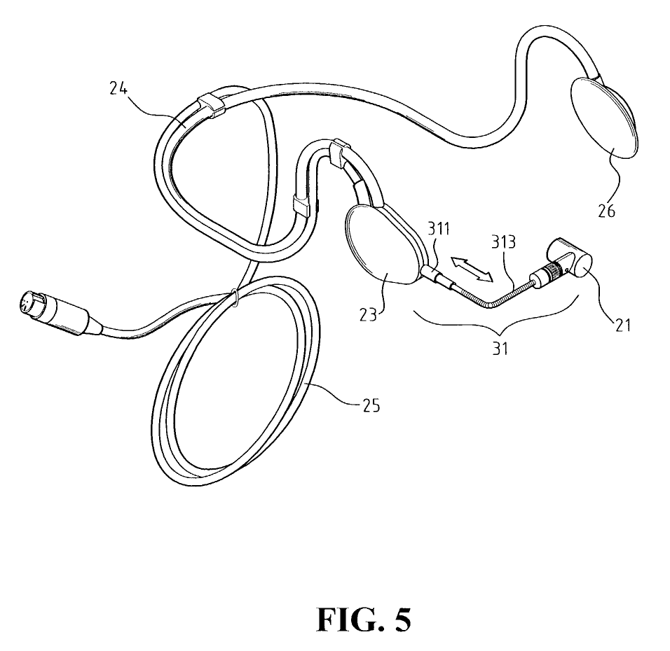

FIG. 5 shows an application example of this invention. In FIG. 5, a supporting shaft 31 is substituted for the lateral bracket 22 of the prior ear-carrying microphone. The supporting shaft 31 is structured as a two-piece stretchable tube having an upper tube 311 and a lower tube 313, in which the upper tube 311 further comprises a plurality of segments of hard copper tube, which is unbendable but extendable vertically, while the lower tube 313 is bendable; the diameter of the upper tube 311 is slightly smaller than that of the lower tube 313; the upper tube 311 is in connection with an acoustic head while the lower tube 313 with an end of an earphone 23 in an ear-carrying microphone. The supporting shaft 31 might be adjusted for an optimum position of an acoustic head 21 according to a user's head configuration and tightness the user feels fit. An electric cord 25 passing through the supporting shaft 31 and connected also with the acoustic head 21 is arranged in helical form so as to stretch or shrink together with the supporting shaft 31.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A stretchable tube equipped microphone, comprising a supporting shaft connected with an acoustic head, said supporting shaft being a two-piece tube composed of an upper and a lower tube, in which the upper tube is a hard tube for vertical adjustment while the lower tube is a bendable soft tube; the diameter of the upper tube is slightly smaller than that of the lower tube; the upper tube and the lower tube are connected with said acoustic head and a base, respectively; and an electric cord in helical form is arranged in said supporting shaft and connected also with said acoustic head so as to stretch or shrink together with said supporting shaft.

2. The stretchable tube equipped microphone according to claim 1, in which the upper tube of said supporting shaft has a multi-segment stretchable structure.

3. The stretchable tube equipped microphone according to claim 1, in which the upper tube of said supporting shaft is a hard copper tube.

4. A stretchable tube equipped microphone, comprising a supporting shaft connected with an acoustic head, said supporting shaft being a two-piece tube composed of an upper and a lower tube, in which the upper tube is a hard tube for vertical adjustment while the lower tube is a bendable soft tube; the diameter of the upper tube is slightly smaller than that of the lower tube; the upper tube and the lower tube are connected with said acoustic head and an end of earphone, respectively, for application to an ear-carrying microphone; and an electric cord in helical form is arranged passing through said supporting shaft and connected also with said acoustic head so as to stretch or shrink together with said supporting shaft.

5. The stretchable tube equipped microphone according to claim 4, in which the upper tube of said supporting shaft has a multi-segment stretchable structure.

6. The stretchable tube equipped microphone according to claim 4, in which the upper tube of said supporting shaft is a hard copper tube.
